(19) United States
(12) Patent Application Publication
(10) Pub. No.: US 2002/0092936 A1
(43) Pub. Date: Jul. 18, 2002

(54) Fuel injector and relative production method

(75) Inventor: Mario Ricco, Casamassima (IT)

Correspondence Address: WILLIAM R. EVANS, c/o LADAS & PARRY, 26 WEST 61st STREET, NEW YORK, NY, 10023, US

(73) Assignee: C.R.F SOCIETA CONSORTILE PER AZIONI

(21) Appl. No.: 10/034,633

(22) Filed: Dec. 28, 2001

(30) Foreign Application Priority Data
Jan. 16, 2001 (IT) TO2001A000026

(51) Int. Cl. B05B 1/14

(52) U.S. Cl. 239/590

(57) ABSTRACT

A fuel injector has an injector body and a fitting for connecting the injector body to a high-pressure fuel supply conduit. The injector body and the fitting are separate elements of the injector, and are connected to each other to connect the supply conduit and grip an end portion of the supply conduit between the injector body and the fitting.

The present invention relates to a fuel injector.

More specifically, the present invention relates to a fuel injector for an internal combustion engine, to which the following description refers purely by way of example.

### BACKGROUND OF THE INVENTION

A known internal combustion engine fuel injector comprises an injector body housing a fuel metering valve; and a fitting for connecting the injector body to a high-pressure fuel supply conduit. A known injector body is elongated and tubular in shape, extends along a given axis, and is integral with the fitting connecting the body to the high-pressure fuel supply conduit; and the fitting is located along a lateral wall of, and projects radially with respect to, the injector body. The injector body and fitting are formed from a single rough piece of metal which is hot forged to form an elongated semifinished part having a laterally-extending portion imparting an symmetrical shape to the semifinished part. The asymmetrical semifinished part is then machined to define the injector body and the fitting according to given design parameters, and in particular according to given dimensions, tolerances and surface finish.

Known injectors are expensive to produce on account of the type and number of mechanical operations involved in producing the injector body and fitting, and of which forging is especially expensive and difficult to implement in a continuous-flow system.

### SUMMARY OF THE INVENTION

It is an object of the present invention to provide an injector which can be produced using a production method which is much cheaper than those of known injectors, but which at the same time provides for at least the same quality standard.

According to the present invention, there is provided a fuel injector comprising an injector body connectable to a high-pressure fuel supply conduit, and a fitting for connecting said supply conduit to said injector body; the injector being characterized in that said injector body and said fitting are separate elements of said injector and connected to each other.

Such an injector provides not only for eliminating high-cost forging, but also for simplifying machining, on account of the injector body being symmetrical and so adapting better to automatic handling and practically any type of machining operation.

In a preferred embodiment of the invention, the injector body is machined from a bar.

This solution is especially advantageous by the semifinished part being formed from a bar, so that forging is replaced by a cutting operation which is easily implemented in a continuous-flow system. Moreover, the semifinished part, like the injector body, is already symmetrical.

The present invention also relates to a method of producing the injector according to the present invention.

According to the present invention, there is provided a method of producing a fuel injector, characterized by cutting off a bar a cylindrical semifinished part to form the injector body.

In a preferred embodiment of the method according to the present invention, an end portion of the supply conduit is deformed between the injector body and the fitting.

This solution is especially advantageous by not requiring that the fitting be fixed hermetically to the injector body, in that the fitting provides for gripping and deforming the end portion of the supply conduit between itself and the injector body to form a hermetic seal between the injector body and the supply conduit. Hermetic sealing is ensured by deformation of the end portion of the supply conduit gripped between the injector body and the fitting.

### BRIEF DESCRIPTION OF THE DRAWINGS

A non-limiting embodiment of the present invention will be described by way of example with reference to the accompanying drawings, in which:

FIG. 1 shows a view in perspective of an injector;

FIG. 2 shows a larger-scale section of part of the FIG. 1 injector;

FIGS. 3a-3d show, schematically, a number of steps in the method of producing the FIG. 1 injector.

### DETAILED DESCRIPTION OF THE INVENTION

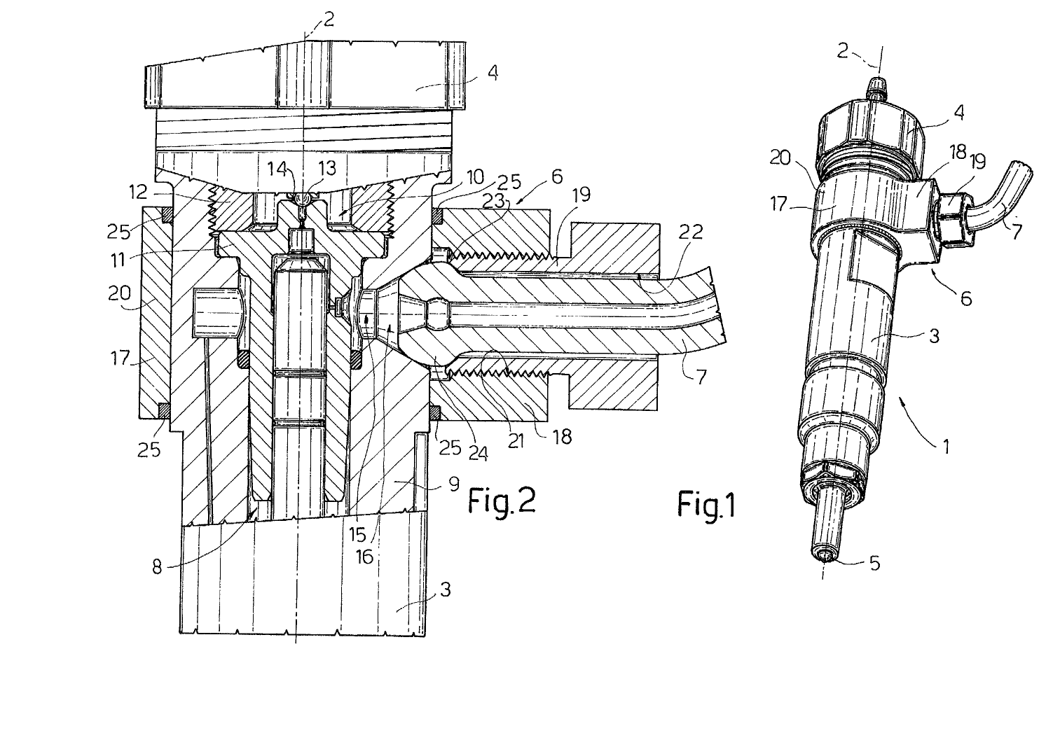

Number 1 in FIG. 1 indicates as a whole an internal combustion engine fuel injector.

Injector 1 extends along an axis 2 and comprises an injector body 3; a cap 4 fixed to injector body 3; a nozzle 5 fixed to injector body 3 at the opposite end to cap 4; and a fitting 6 fixed to injector body 3 to connect injector body 3 to a high-pressure fuel supply conduit 7. The pressure of the fuel fed along supply conduit 7 exceeds a thousand bars.

With reference to FIG. 2, injector body 3 is tubular, and comprises an inner chamber 8 defined laterally by a substantially cylindrical wall 9. Injector 1 comprises a valve 10 housed in chamber 8 and in turn comprising a valve body 11 fixed to injector body 3 by a ring nut 12, and a shutter 13 held inside a seat 14 in valve body 11 by a spring not shown in FIG. 2. Injector body 3 comprises a hole 15 which extends through a cylindrical portion of wall 9 to form an opening permitting access to inner chamber 8 of injector 1, and which has a flared or truncated-cone-shaped portion 16 to form a funnel flaring outwards of wall 9.

Fitting 6 comprises a substantially cylindrical ring 17; an attachment 18 integral with and projecting from ring 17; and a sleeve 19 fitted to attachment 18. Ring 17 has a cylindrical wall 20 blending with attachment 18 and which fits about wall 9 of injector body 3; attachment 18 has a threaded hole 21 which, when fitting 6 is connected to injector body 3, is aligned with hole 15; and sleeve 19 is threaded externally, is screwed to attachment 18, and has a hole 22, an end portion 23 of which is flared or truncated-cone-shaped and faces flared portion 16 of hole 15.

Conduit 7 is smaller in diameter than hole 22 of sleeve 19, and comprises a ring-shaped end portion 24 larger in diameter than hole 22. In actual use, end portion 24 of conduit 7 is located between injector body 3 and sleeve 19, at flared portion 16 of hole 15 on one side, and at flared portion 23 of hole 22 on the opposite side, and is gripped between sleeve 19 and injector body 3 to deform the material of end portion 24 and so ensure hermetic sealing of the high-pressure fuel with no need for seals.

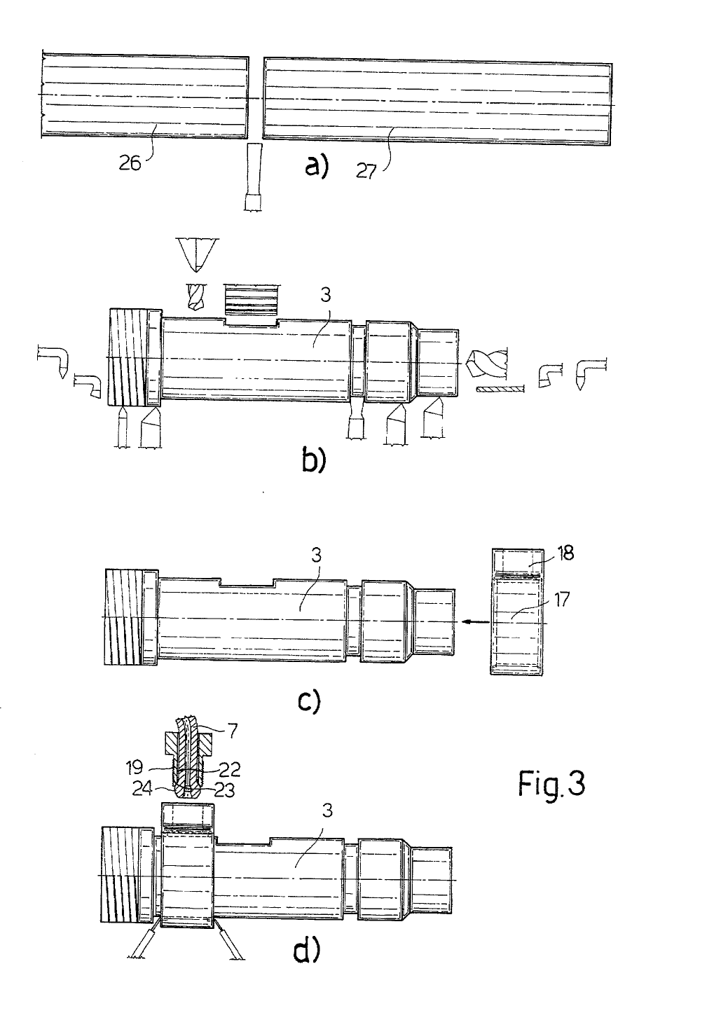

With reference to FIGS. 3a and 3b, no forging is required, only machining and assembly operations, to produce injector 1; and injector body 3 is machined from a bar 26 of metal.

As shown in FIG. 3a, bar 26 is cut into semifinished parts 27, each of which is machined, as shown schematically by various machining tools in FIG. 3b, to form injector body 3 to prescribed dimensions, tolerances and surface finish. Once formed, injector body 3 is connected to fitting 6 as shown in FIGS. 3c and 3d. Fitting 6 is formed separately by means of similar machining operations, and is then fixed to injector 3 by brazing or weld spots 25 which distribute stress about ring 17 when gripping conduit 7, and which keep hole 21 aligned with hole 15. FIGS. 3c and 3d show connection of injector body 3 to ring 17 and attachment 18 of fitting 6, though valve 10, nozzle 5, cap 4 and other component parts of injector 1 not shown in the drawings may be fitted first.

Once ring 17 is fixed to injector body 3, sleeve 19 is fitted about supply conduit 7 and screwed to attachment 18 to grip and deform end portion 24 of conduit 7 between injector body 3 and fitting 6.

Clearly, changes may be made to the form of the fitting without departing from the scope of the present invention. For example, in a variation (not shown) of the present invention, the fitting comprises, in place of ring 17 and attachment 18, a cylindrical ring having a threaded hole defining an attachment for sleeve 19, so that the injector is even simpler to produce by simplifying the fitting.

1) A fuel injector comprising an injector body (3) connectable to a high-pressure fuel supply conduit (7), and a fitting (6) for connecting said supply conduit (7) to said injector body (3); the injector being characterized in that said injector body (3) and said fitting (6) are separate elements of said injector (1) and connected to each other.

2) An injector as claimed in claim 1, characterized in that said injector body (3) is formed from a bar (26) by means of machining operations.

3) An injector as claimed in claim 1, characterized in that said injector body (3) is tubular, and comprises a wall (9) and a hole (15) in said wall (9) to receive high-pressure fuel through said hole (15); said fitting (6) being fixed along said wall (9) and at said hole (15).

4) An injector as claimed in claim 3, characterized in that said fitting (6) comprises a ring (17) integral with an attachment (18) having a hole (21); said ring (17) being located about said wall (9) of the injector body (3), and the hole (21) in said attachment (18) being aligned with the hole (15) in the injector body (3).

5) An injector as claimed in claim 4, characterized in that said fitting (6) comprises a threaded sleeve (19); the hole (21) in the attachment (18) being threaded to connect said sleeve (19) to said attachment (18).

6) An injector as claimed in claim 5, characterized in that said supply conduit (7) comprises a ring-shaped end portion (24); said end portion (24) being located between the injector body (3) and said sleeve (19) so as to be gripped between the injector body (3) and sleeve (19); and said sleeve (19) having a hole (22) for housing said supply conduit (7).

7) An injector as claimed in claim 6, characterized in that the hole (15) in the injector body (3) has a flared portion (16), and the hole (22) in said sleeve (19) has a flared portion (23) facing the flared portion (16) of the hole (15) in the injector body (3); said end portion being located between the injector body (3) and the sleeve (19), at the flared portions (16, 23) of the respective holes (15, 22).

8) An injector as claimed in claim 4, characterized in that said ring (17) is fixed to the wall (9) of the injector body (3) by brazing.

9) An injector as claimed in claim 4, characterized in that said ring (17) is fixed to the wall of the injector body (3) by weld spots (25).

10) An injector as claimed in claim 1, characterized in that said injector (1) is an injector (1) for internal combustion engines.

11) A method of producing a fuel injector (1) as claimed in claim 1, characterized by cutting off a bar (26) a cylindrical semifinished part (27) to form said injector body (3).

12) A method as claimed in claim 11, characterized by machining said semifinished part (27) to form said injector body (3).

13) A method as claimed in claim 12, characterized by connecting the injector body (3) to said fitting (6).

14) A method as claimed in claim 13, characterized by deforming an end portion (24) of said supply conduit (7) between said injector body (3) and said fitting (6).

15) A method as claimed in claim 14, characterized in that said fitting (6) comprises a threaded attachment (18) fixed to said injector body (3); and a sleeve (19) about said supply conduit (7); the method comprising screwing said sleeve (19) to said attachment (18) to fix said supply conduit (7) to the injector body (3).

16) A method as claimed in claim 15, characterized by gripping said end portion (24) of said supply conduit (7) between said injector body (3) and said sleeve (19).

17) A method as claimed in claim 13, characterized in that said fitting comprises a ring (17); the method comprising fixing the injector body (3) to said ring (17) by brazing.

18) A method as claimed in claim 13, characterized in that said fitting (6) comprises a ring (17); the method comprising spot-welding the injector body (3) to said ring (17).
